(19) United States
(12) Patent Application Publication
(10) Pub. No.: US 2024/0410523 A1
(43) Pub. Date: Dec. 12, 2024

(54) Magnetic Device Holder

(71) Applicant: Christian Frederick Caspersen, Roswell, GA (US)

(72) Inventor: Christian Frederick Caspersen, Roswell, GA (US)

(21) Appl. No.: 18/734,107

(22) Filed: Jun. 5, 2024

Related U.S. Application Data
(60) Provisional application No. 63/471,555, filed on Jun. 7, 2023.

(51) Int. Cl. F16M 13/02; A63B 57/30; B60R 11/00; B60R 11/02; F16M 11/04; F16M 11/12; H01M 10/46

(52) U.S. Cl. CPC F16M 13/022; A63B 57/353; B60R 11/00; F16M 11/041; F16M 11/128; B60R 2011/0022; B60R 2011/0057; B60R 2011/0089; B60R 11/0241; B60Y 2200/86; H01M 10/46

(57) ABSTRACT

A magnetic device holder is an Apple iphone holder or other device holder for the cart. The magnetic device holder leverages strong (N52) magnets that adhere to the metal canopy pole and another set of magnets that leverage the MagSafe technology built into certain iPhones (iPhone 12 or newer).

### CROSS-REFERENCE TO RELATED APPLICATIONS

This patent claims priority to and the benefit of the filing date of U.S. provisional patent application Ser. No. 63/471,555, titled “The Phone Caddy is an Apple iphone holder for the cart” and filed Jun. 7, 2023, the entire contents of which are hereby incorporated by this reference.

### BACKGROUND

Magnetic mounts are known for holding devices such as Apple phones and other devices with Apple designed ‘MagSafe’ technology. Existing mount technology, however, is not suitable for use with golf carts, for instance, and has much room for improvement.

### SUMMARY

The magnetic device holder described herein is a phone or mobile device accessory made to be used with Apple phones and or other devices with Apple designed ‘MagSafe’ technology or with other devices with similar technology, which allows the phone or other mobile device to be mounted securely on a golf cart windshield strut or other structure.

In one example, the magnetic device holder offers users with a magnetic connection to hold a phone in place at will and with no mechanical requirements to secure the phone to the mounting device. The only connection between the phone mounting device to the golf cart is made through a strong N52 rated magnetic connection. Similarly, the strength of magnets in the device maintains a strong, non-mechanical connection to the phone of other such devices with a MagSafe connection. The magnetic device holder uses magnets to hold the product to the golf cart's roof support strut. This magnetic device holder is specifically designed to be mounted to metal and to the upright structural steel supports of a golf cart roof. Golf cart vehicles are not unlike any other seated, motorized conveyance except they have nontraditional dash boards and no ventilation systems where many car mounted phone mounts will not work. This product utilizes the primary vertical roof support to attach a magnetic base as its primary means of connection to the vehicle. The mount is having a magnetic connection to ferrous metals and such metal surface will allow the use of this type pot mount. The mount may be used in Golf Cars, sheet metal on cars and other steel like golf clubs. The mount does not use screw tightening meds or Velcro type straps to affix to the intended metal surfaces. The strength of the magnet attaching to the golf cart is greater than the foot pounds of strength of the second MagSafe magnet which is holding the phone.

Other products on the market lack the magnet technology built into the phone caddy. The allows you instant access to your iPhone and all of its technology while using a cart.

The Phone Caddy leverages strong (N52) magnets that adhere to the metal canopy pole and another set of magnets that leverage the MagSafe technology built into certain iPhones (iPhone 12 or newer).

### BRIEF DESCRIPTION OF FIGURES

FIGS. 1-6 show an example of a magnetic device holder.

FIG. 7 shows another example of a magnetic device holder with a battery incorporated into the base of the holder.

FIGS. 8-11 show another example of a magnetic device holder including a battery pack cradle configured to receive a battery pack.

FIGS. 12-15 show examples of magnet configurations of magnetic device mounts and magnetic bases.

### DETAILED DESCRIPTION OF FIGURES

As stated above, in some examples, the magnetic device holder described is a phone or mobile device accessory made to be used with Apple phones and or other devices with Apple designed ‘MagSafe’ technology, or with similar devices. The magnetic mounting technology offers users with a magnetic connection to hold a phone in place at will and with no mechanical requirements to secure the phone to the mounting device. In some implementations the only connection between the phone mounting device to the golf car is made through a strong N52 rated magnetic connection. Similarly, the strength of magnets in the device maintains a strong, non-mechanical connection to the phone or other such devices with a MagSafe connection. The product uses magnets to hold the product to the golf car's roof support strut. This mount is specifically designed to be mounted to metal and to the upright structural steel supports of a golf car roof. Golf car vehicles are not unlike any other seated, motorized conveyance except they have nontraditional dash boards and no ventilation systems where many car mounted phone mounts will not work. This product utilizes the primary vertical roof support to attach a magnetic base as its primary means of connection to the vehicle. The mount is having a magnetic connection to ferrous metals and such metal surface will allow the use of this type pot mount. The mount may be used in Golf Cars, sheet metal on cars and other steel like golf clubs. The mount does not use screw tightening meds or Velcro type straps to affix to the intended metal surfaces. The strength of the magnet attaching to the golf cart is greater than the foot pounds of strength of the second MagSafe magnet which is holding the phone.

In some implementations this phone mount for Apple phones and or other devices with MagSafe technology offers users with a magnetic connection to hold a phone in place at will. With no mechanical connection, only by the strength of magnets the phone of other such devices with a MagSafe connection would be able to freely rotate for ease of viewing. Unlike phone mounting systems for your car, this mount is specifically designed to be mounted to metal and more specifically in the application in use with a golf cart. Golf cart vehicles are not unlike any other seated, motorized conveyance except they have nontraditional dash boards and or ventilation systems where many car mounted phone mounts will not work. This product utilizes the primary vertical roof support to attach a magnetic base as its primary means of connection to the vehicle.

In some implementations the magnetic device holder uses magnets to hold the product to the golf cart roof support strut. There is another ring magnet to connect to the phone's backside. The strength of the magnet attaching to the golf cart is greater than the foot pounds of strength of the magnet that hold the phone. The product may temporary or it may stay affixed with magnetic connectivity. There can be adjustment to the viewing angle of the phone in 3 axis. There are knobs which allow this morning system to be adjusted and affixed with an increased connection adjusting knobs to right tighten and left turn loosen the mounts with increased friction and pressure between the assembled parts. There are covers over each magnet on both sides of the device so they are not exposed or indirect contact with the golf cart or phone. These cover parts are made of a soft elastomer materials which offers protection from scratches as well as a softer mount condition to the user.

In some implementations the magnetic device holder is made from 5 plastic parts and metal hardware parts; plastic base part, plastic main stem part, plastic ring part, plastic knob 1 and plastic knob 2, each knob is the same geometry plastic part. Screw type used in this design is 10-32 and is comprised of 2 steel carriage bolts with lengths or 1″ and 1.25″. These screw types allow for a firm hold when tightened and allows user to position device in any of 150 degree viewing angles. Each bolt hardware part is addressed in the final assembly with a custom plastic knob at the top to make adjustment easier and more controlled. A 10-32 steel nut accepts the 1.25″ bolt which clamps through the 2 main adjusting portions of the design. The two main adjusting portions of the design is the base plastic part and the plastic main stem part which rotates in one axis. The other adjusting parts of the assembly are the main ring part which twists in one axis on the main stem part. The knob which is 1″ in length connects the main stem part and ring part to allow adjustment, secure the parts in use and complete the assembly. The design of these adjustable functions for many different view angles to make accessing the device seamless, record activities while outside of the cart, and provide a customized experience based on user preferences.

In some implementations there is an insert that has been developed to allow for branding and other customization which can be removed in order to mark a ball while golfing. The round insert has a soft material around the edges to fit within the ring magnet. It is removable and can be stored on the magnetic device holder while not in use.

In some implementations above the base magnet is a 5,000 mAH battery to charge a phone using the MagSafe ring magnet to conduct the energy. This battery will provide ongoing pass through charging capability utilizing a USB A connection that is found in most golf carts. Further, the 5,000 mAH battery will also store energy to provide a wireless charging capability.

In some implementations there can be adjustment to the viewing angle of the phone in 3 axis. There are knobs which control screw heads which allow the mounting system to be adjusted and affixed with an increased connection adjusting knobs to right tighten and left turn loosen the mounts with increased friction and pressure between the assembled parts. There are covers over each magnet on both sides of the device so they are not exposed or indirect contact with the golf cart or phone. These cover parts are made of a soft elastomer materials which offers protection from scratches as well as a softer mount condition to the user.

In some implementations the device may be plugged into a USB A connection found in most golf carts and turn the device to the ‘on’ position the device will charge through this connection. If a USB A connection is not available simply charge battery and turn the device to the ‘on’ position to provide up to 2 to 3 full charges when auxillary battery has full charging capability.

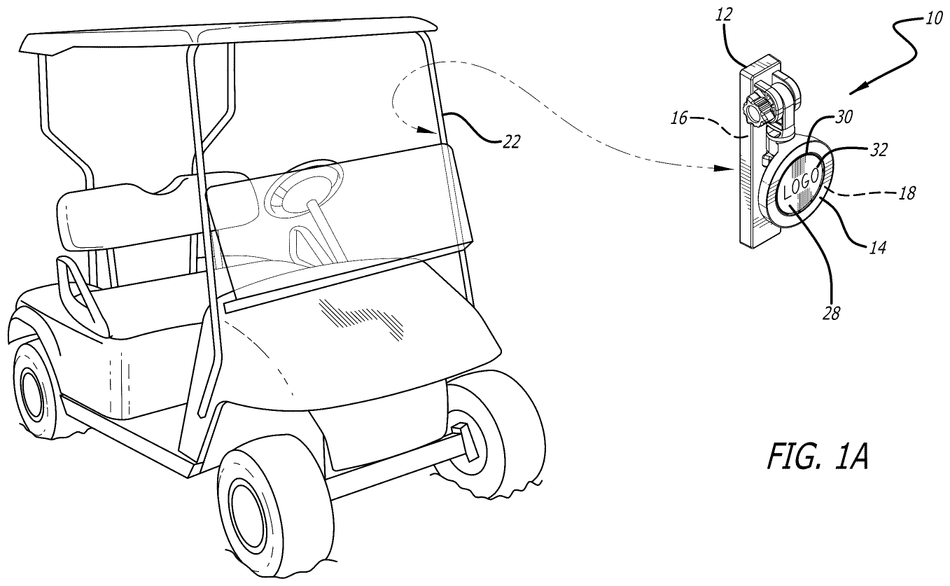

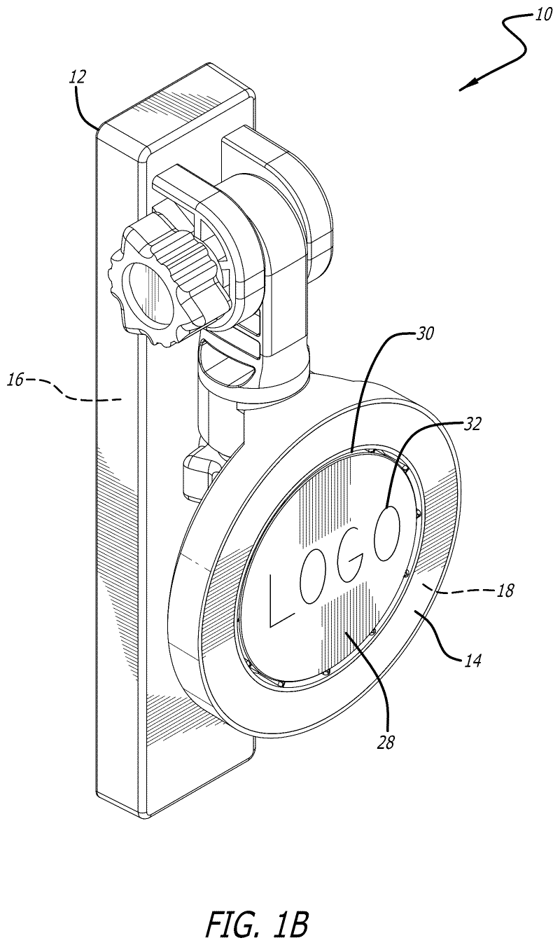

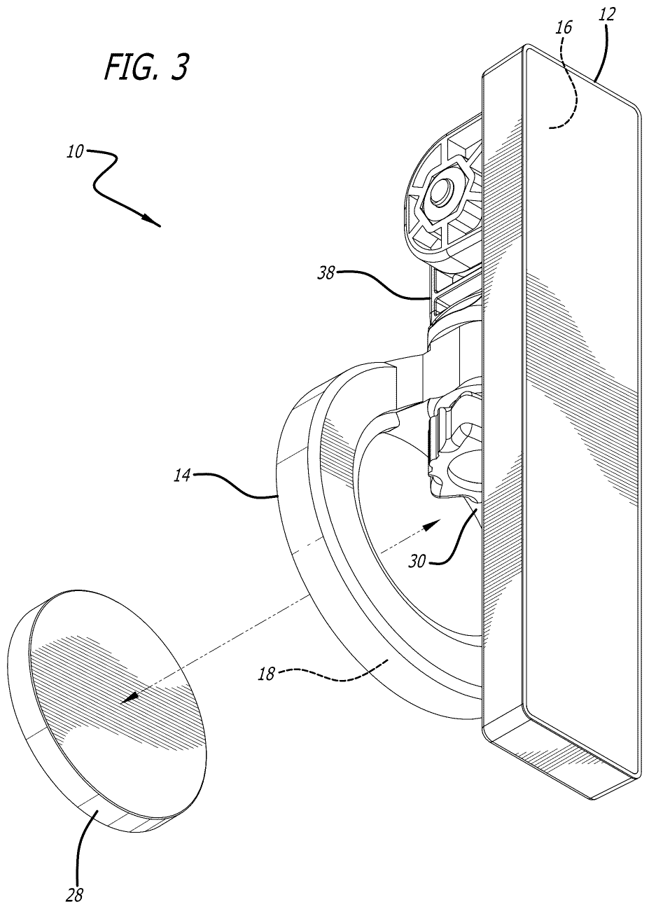

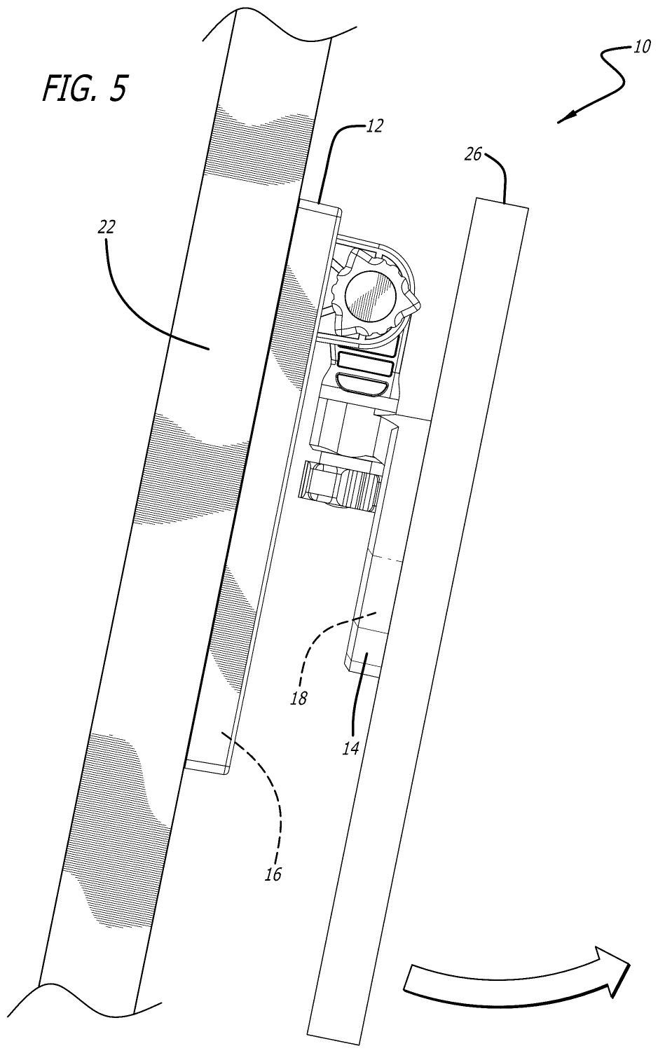

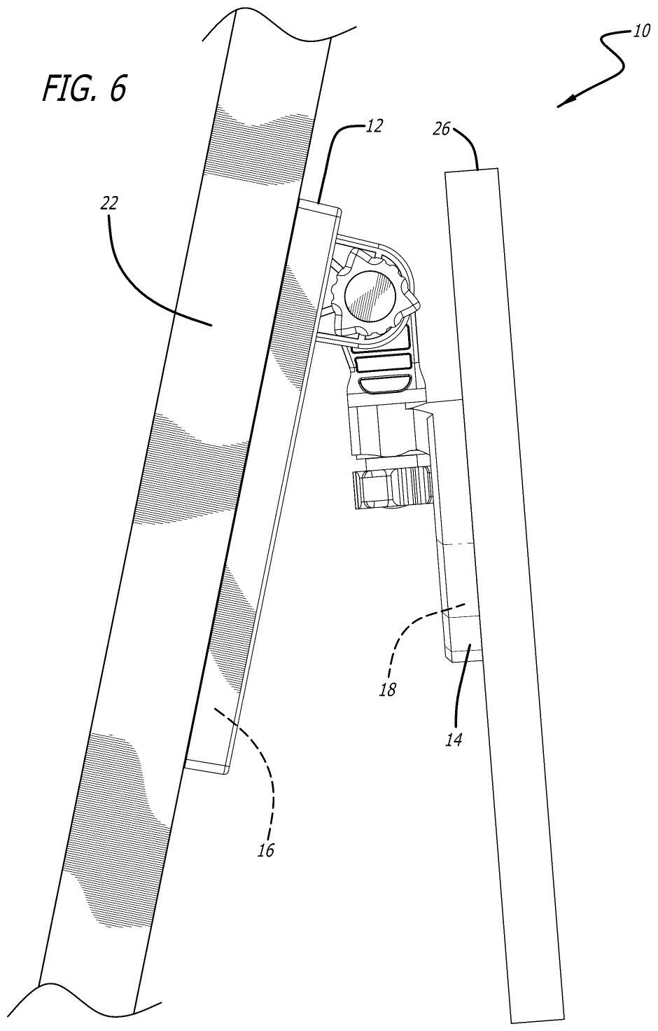

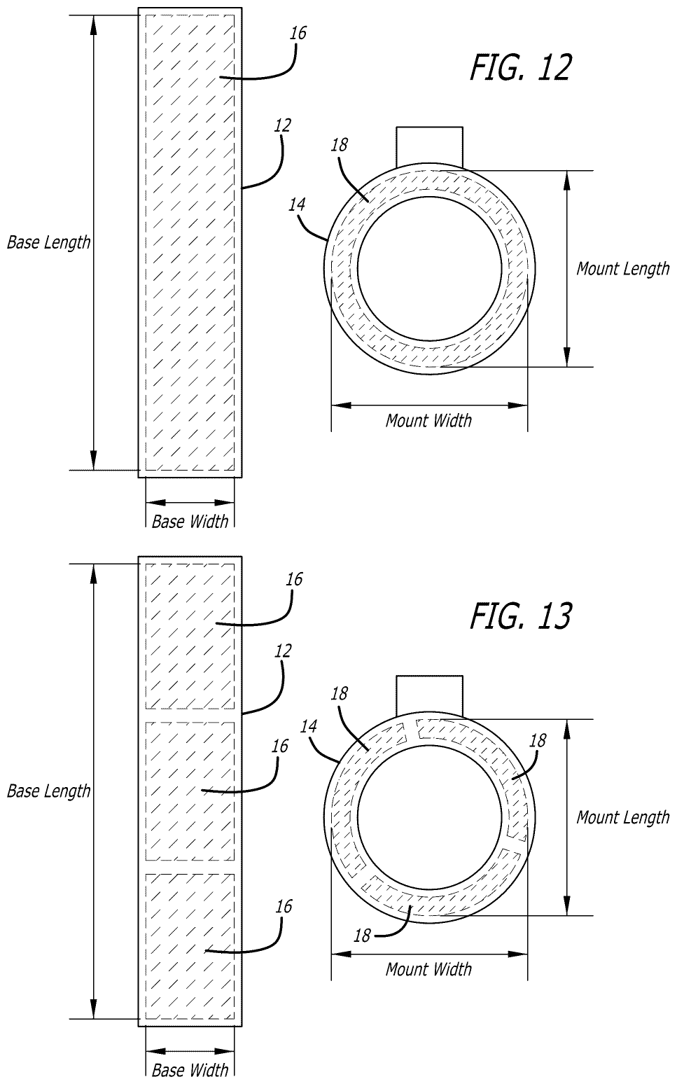

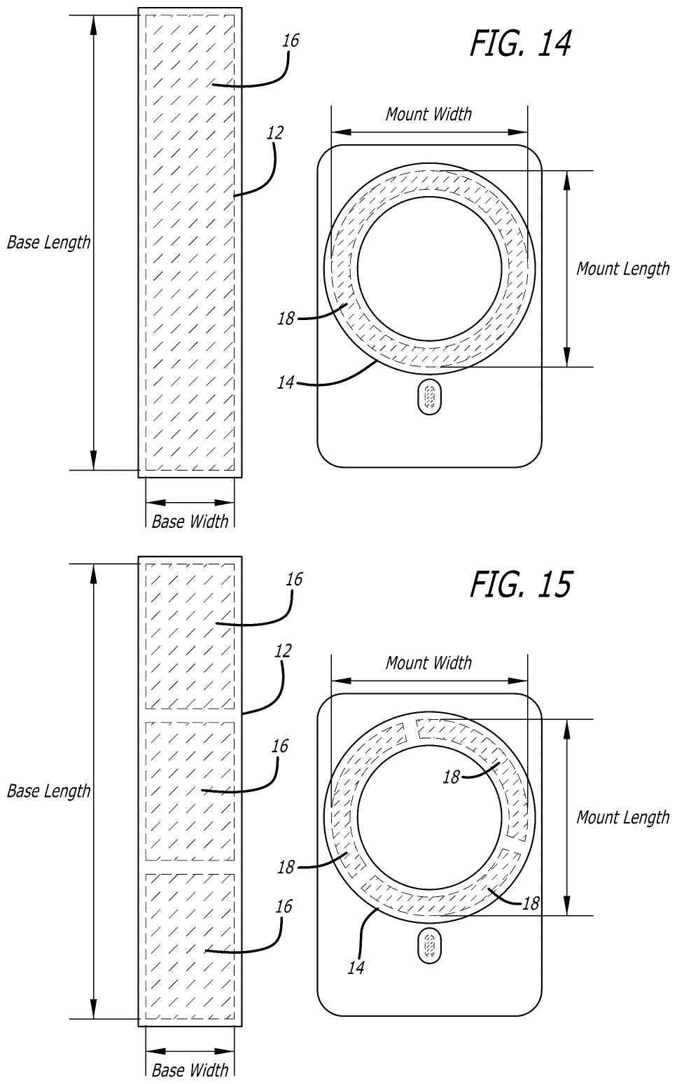

FIGS. 1-6 show an example of a magnetic device holder 10. The magnetic device holder 10 includes an elongated magnetic base 12 and a magnetic device mount 14. The elongated magnetic base 12 includes a configuration of one or more base magnets 16 spanning a base width and a base length. The magnetic device mount 14 includes a ring shaped configuration of one or more device magnets 18 spanning a mount width and a mount length. FIGS. 12 and 13 illustrate non-limiting illustrations of base and device magnet 16, 18 configurations. In FIG. 12 the configuration of base magnet(s) takes the form of a single elongated bar magnet 16, and the configuration of device magnet(s) takes the form of a single ring magnet 18. In FIG. 13 the configuration of base magnet(s) takes the form of a series of three rectangular bar magnets 16 in a rectangular-shaped array, and the configuration of device magnet(s) takes the form of a series of three partially ring shaped magnets 18 in a ring-shaped array. Other configurations are also possible and within the scope of the present invention. For example, a set of four or more small rectangular magnets could be created in a ring shaped array instead of the three curved magnets shown in FIG. 13.

As shown in FIGS. 12 and 13, the base length is longer than the mount length, and the base width is shorter than the mount width. The inventor has discovered that such a configuration of magnets provides an easy to use and reliable way to connect a magnetic device holder to a structure such as an upright windshield strut of a golf cart. In some implementations the base length is at least 150% of the mount length. In some implementation the base length is at least 200% of the mount length.

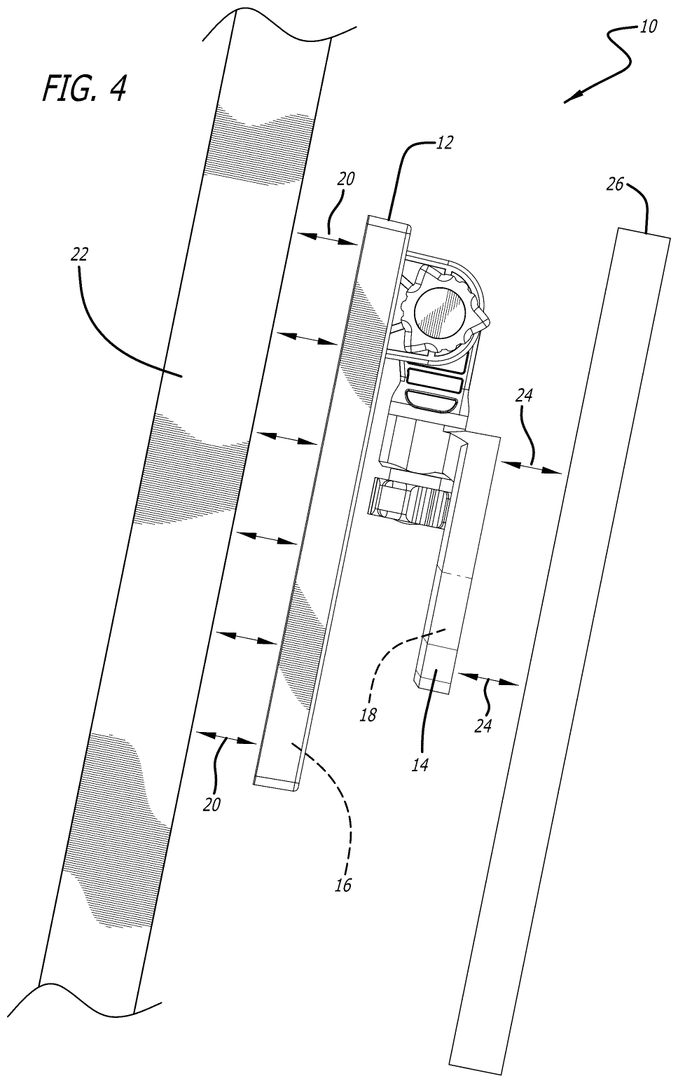

As shown in FIG. 4, the base magnet(s) 16 have a base magnetic pull strength 20 relative to the golf cart strut 22, and the device magnet(s) 18 have a mount magnetic pull strength 24 relative to the phone or other device 26. In some implementations the base magnetic pull strength 20 may be at least 125% of the mount magnetic pull strength 24. In some implementations the base magnetic pull strength 20 may be at least 150% of the mount magnetic pull strength 24. In some implementations the base magnetic pull strength 20 may be at least 200% of the mount magnetic pull strength 24.

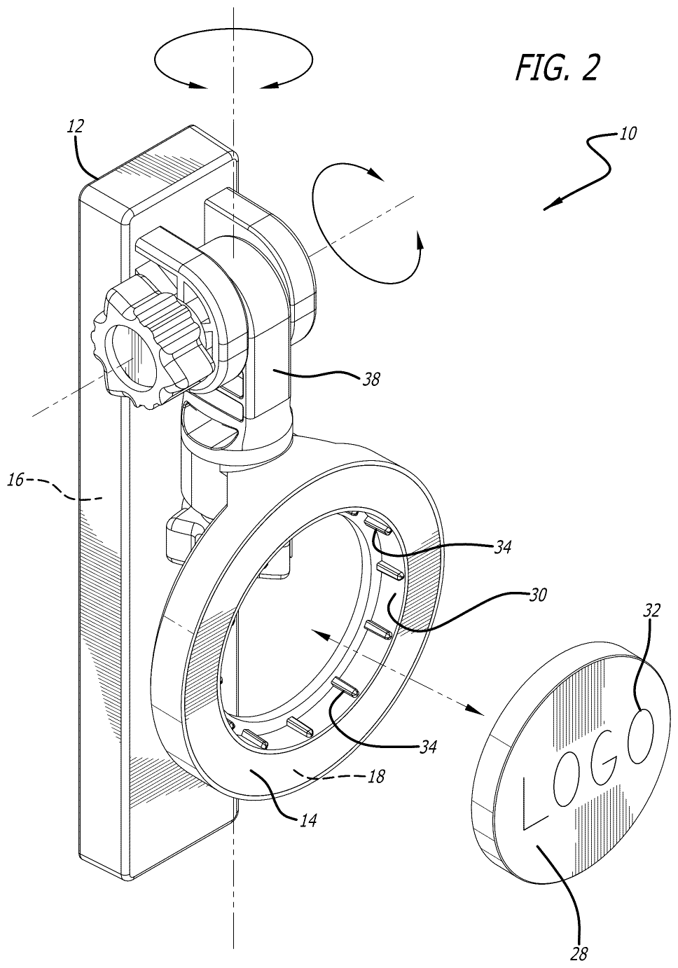

In the example of FIGS. 1-6 the magnetic device holder 10 also includes an insert 28. The magnetic device mount 14 includes a recess 30. The insert 28 is removably held in the recess 30. The recess 30 may take the form of an aperture inside the ring shaped configuration of device magnet(s) 18, and may include protrusions 34 (see FIG. 2) for holding the insert 28 in the aperture by a friction fit. In this example the insert 30 is disc shaped and includes indicia 32 on at least one surface. The indicia 32 may be any desired branding or other indicia applied to the insert 28, and may be customizable.

In the example of FIGS. 1-6 the magnetic device holder 10 also includes an arm 38 connecting and extending between the elongated magnetic base 12 and the magnetic device mount 14. The arm 38 may be connected to both the base 12 and the mount 14 in a rotating fashion by adjustment knobs 40 or similar components, thereby allowing adjustment of the mount 14 relative to the base 12 about multiple degrees of freedom.

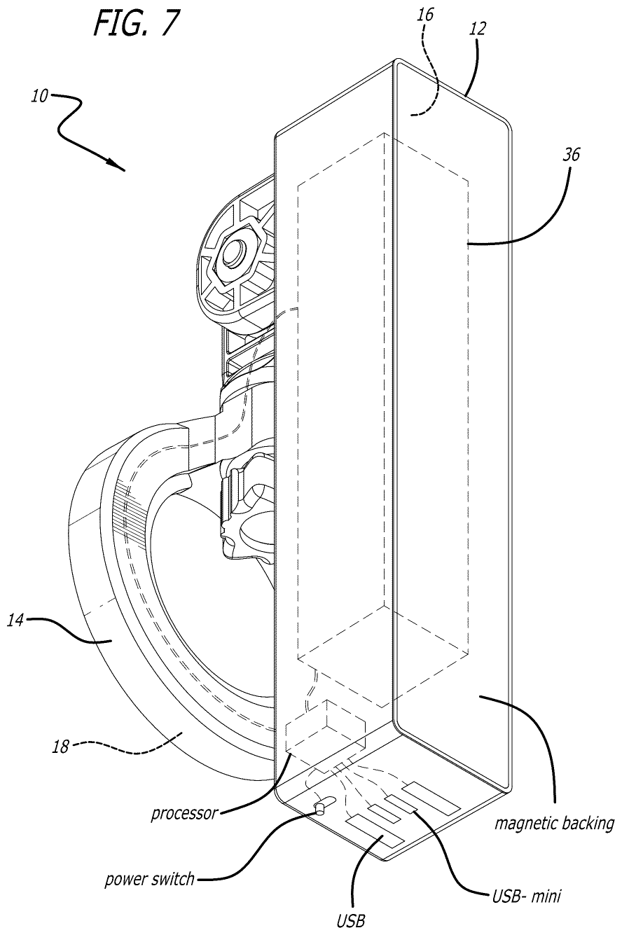

FIG. 7 shows another example of a magnetic device holder 10. In this example the magnetic device holder 10 includes a rechargeable battery 36 that is electrically coupled to the magnetic device mount 14. More specifically the battery 36 is located in the elongated magnetic base 12. The rechargeable battery 36 is configured to create a magnetic field at the magnetic device mount 14 for charging the battery of a suitably configured phone or other wireless device.

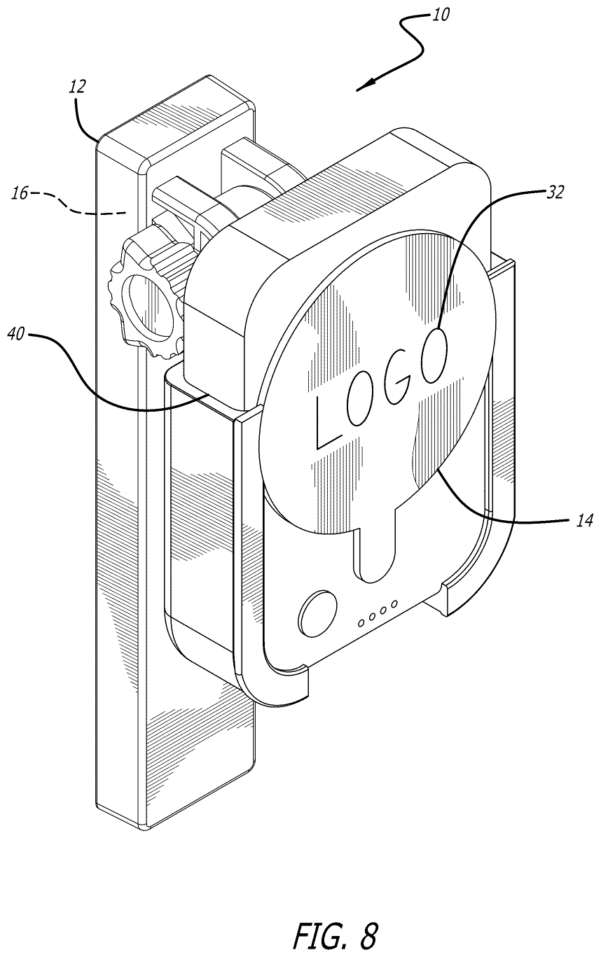

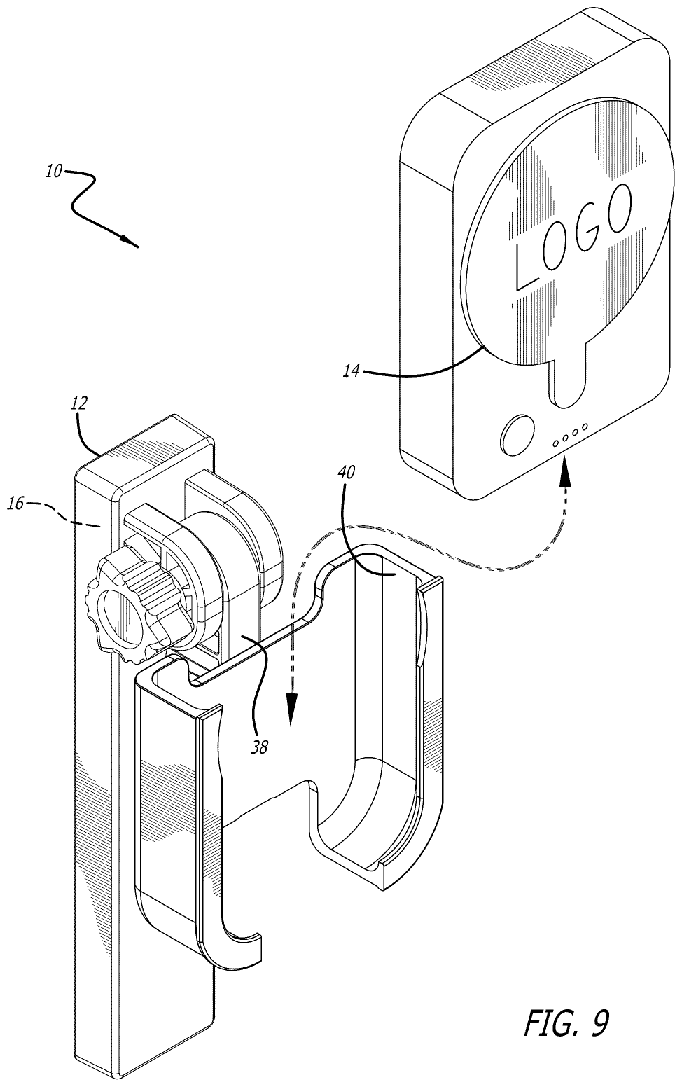

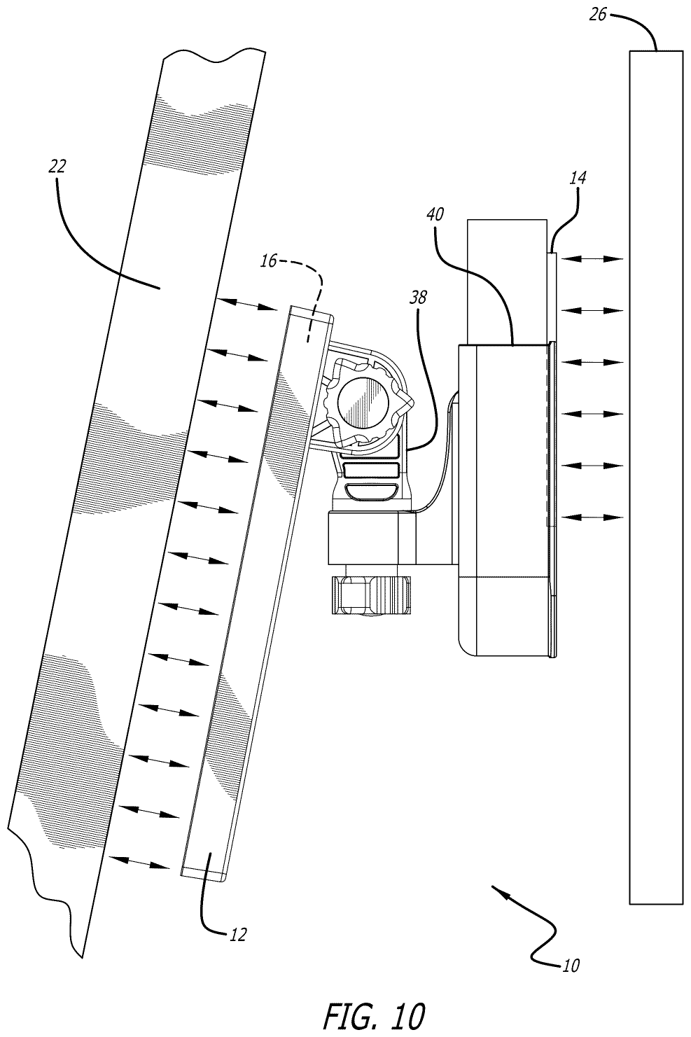

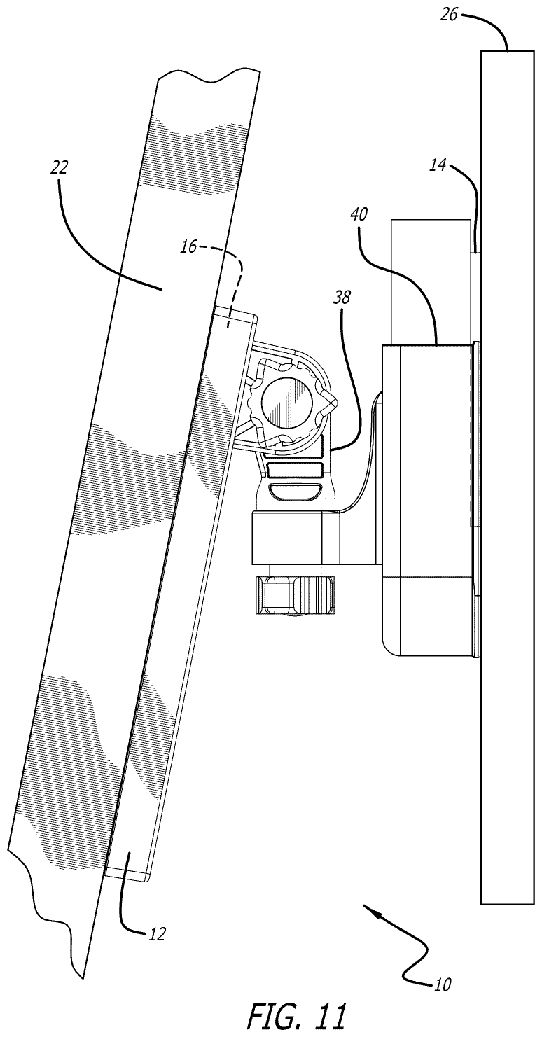

FIGS. 8-11 show another example of a magnetic device holder 10. In this example the device mount 14 is a battery pack including (internally) the ring shaped configuration of one or more device magnets. The battery pack in this example is configured to both hold the phone 26 or other device and also to charge the phone 26 or other device. In this example the magnetic device holder 10 further includes a battery pack cradle 40 adjustably connected to the magnetic base 12 via arm 38, which serves as an adjustable connector configured to connect the battery pack cradle 40 to the base 12 in a tilting fashion. The cradle 40 is configured to receive the battery pack in a removable fashion (in this instance by sliding into recesses in the cradle 40).

The above description has been provided by way of example only. Changes, including additions, deletions, substitutions, and other modifications may be made to the above examples without departing from the scope or spirit of the present inventions as set forth in the following claims.

1. A magnetic device holder comprising:
(a) an elongated magnetic base comprising a configuration of one or more base magnets, the configuration of one or more base magnets spanning a base width and a base length;
(b) a magnetic device mount connected to the elongated magnetic base and comprising a ring shaped configuration of one or more device magnets, the ring shaped configuration of one or more device magnets spanning a mount width and a mount length;
(c) wherein the base length is longer than the mount length; and
(d) wherein the base width is shorter than the mount width.

2. The magnetic device holder of claim 1 wherein the device mount comprises a battery pack, the battery pack comprising the ring shaped configuration of one or more device magnets.

3. The magnetic device holder of claim 2 further comprising a battery pack cradle connected to the elongated magnetic base, the battery pack cradle configured to receive the battery pack in a removable fashion.

4. The magnetic device holder of claim 3 further comprising an adjustable connector configured to connect the battery pack cradle to the elongated magnetic base in a tilting fashion.

5. The magnetic device holder of claim 1 wherein the configuration of one or more base magnets comprises a base magnetic pull strength, wherein the configuration of one or more device magnets comprises a mount magnetic pull strength, wherein base magnetic pull strength is at least 125% of the mount magnetic pull strength.

6. The magnetic device holder of claim 5 wherein the base magnetic pull strength is at least 150% of the mount magnetic pull strength.

7. The magnetic device holder of claim 5 wherein the base magnetic pull strength is at least 200% of the mount magnetic pull strength.

8. The magnetic device holder of claim 5 wherein the base length is at least 150% of the mount length.

9. The magnetic device holder of claim 8 wherein the base length is at least 200% of the mount length.

10. The magnetic device holder of claim 1 wherein the configuration of one or more base magnets comprises an elongated bar magnet.

11. The magnetic device holder of claim 1 wherein the configuration of one or more one base magnets comprises a plurality of magnets arranged in a rectangular-shaped array.

12. The magnetic device holder of claim 1 wherein the ring shaped configuration of at least one device magnets comprises a ring shaped magnet.

13. The magnetic device holder of claim 1 wherein the ring shaped configuration of at least one device magnets comprises a plurality of device magnets arranged in a ring-shaped array.

14. A magnetic device holder comprising:
(a) a magnetic base comprising a configuration of at least one base magnets;
(b) a magnetic device mount connected to the elongated magnetic base and comprising a ring shaped configuration of at least one device magnets, the magnetic device mount comprising a recess;
(c) an insert removably held in the recess.

15. The magnetic device holder of claim 14 wherein the insert comprises a disc shaped and an indica on at least one surface of the disc shape.

16. The magnetic device holder of claim 15 wherein the recess comprises an aperture positioned inside the ring shaped configuration of at least one device magnets, and wherein the magnetic device mount comprises a plurality of protrusions for holding the insert in the aperture by a friction fit.

17. A magnetic device holder comprising:
(a) an elongated magnetic base comprising a configuration of at least one base magnets;
(b) a magnetic device mount connected to the elongated magnetic base and comprising a ring shaped configuration of at least one device magnets;
(c) a rechargeable battery positioned between the configuration of at least one base magnets and the magnetic device mount, wherein the rechargeable battery is electrically coupled to the magnetic device mount, wherein the rechargeable battery is configured to create a magnetic field at the magnetic device mount.

18. The magnetic device mount of claim 17 wherein the rechargeable battery is located in the elongated magnetic base.

19. The magnetic device mount of claim 18 further comprising an arm connecting and extending between the elongated magnetic base and the magnetic device mount.
